(19) United States
(12) Patent Application Publication
(10) Pub. No.: US 2016/0349846 A1
(43) Pub. Date: Dec. 1, 2016

(54) ELECTRONIC DEVICE, INPUT APPARATUS, AND DRIVE CONTROLLING METHOD

(71) Applicant: FUJITSU LIMITED, Kawasaki-Shi (JP)

(72) Inventors: Yohei SUGIURA, Kawasaki (JP); Nobutoshi KUMAGAI, Kawasaki (JP); Arata JOGO, Kawasaki (JP); Makoto SAOTOME, Kawasaki (JP); Yasuhiro ENDO, Ebina (JP); Yuichi KAMATA, lsehara (JP); Kiyoshi TANINAKA, Ebina (JP); Akinori MIYAMOTO, Sagamihara (JP)

(73) Assignee: FUJITSU LIMITED, Kawasaki-Shi (JP)

(21) Appl. No.: 15/231,171

(22) Filed: Aug. 8, 2016

Related U.S. Application Data
(63) Continuation of application No. PCT/JP2014/053401, filed on Feb. 14, 2014.

(51) Int. Cl. G06F 3/01; G06F 3/041

(52) U.S. Cl. CPC G06F 3/016; G06F 3/0416; G06F 3/04812

(57) ABSTRACT

An electronic device includes an input apparatus including an input manipulation surface that receives a contact manipulation; a display part configured to display a pointer that moves in response to the contact manipulation; and a controlling part configured to generate a natural vibration in an ultrasound frequency band in the input manipulation surface. The controlling part varies an amplitude of the natural vibration in accordance with a positional change of the pointer on the display part to report a motion of the pointer on the display part.

### CROSS-REFERENCE TO RELATED APPLICATION

This application is a continuation application of International Application PCT/JP2014/053401 filed on Feb. 14, 2014 and designated the U.S., the entire contents of which are incorporated herein by reference.

### FIELD

The embodiment discussed herein relates to an electronic device, an input apparatus usable by an electronic device, and a drive controlling method of an input apparatus.

### BACKGROUND

An input of a conventional computer is performed by manipulating a pointer displayed on a display panel with a mouse, a touch-pad, a click-pad, or the like to manipulate a Graphical User Interface (GUI) on the display panel. Such an input apparatus has a coordinate input part for designating a position of the pointer, a button for selecting the GUI and the like. However, the input apparatus typically does not have an output part that presents an object, displayed as the GUI, in a tactile manner to a user. Ordinarily, the user visually confirms the position of the pointer displayed on the display panel.

A tactile sensation presenting apparatus is known in the related art that generates a tactile vibration that gives a designated tactile sensation to a manipulation portion when a user's finger or the like contacts a display part to perform a manipulation (for example, see Patent Document 1). The tactile sensation presenting apparatus generates the vibration in the contacted portion on the display part. However, the tactile sensation presenting apparatus cannot give a different tactile sensation to the user in accordance with the manipulated portion.

A definition of a screen of a personal computer has become higher and a size of an object such as a mouse cursor and a button displayed on the screen has become smaller. When the button in the screen is small, it is needed to gaze at the screen and to confirm whether the cursor is located on the object such as the objective button before performing selection. Further, in a case of moving the pointer, the user cannot grasp the position of the pointer when the user does not look at the screen. In a case of moving the pointer at a high speed, it becomes difficult to grasp where the pointer is and it becomes easy to lose visual contact with the pointer. Further, when a multi-display is used, it becomes easy to lose visual contact with the pointer and it becomes difficult to find the pointer because the screen becomes wider.

### RELATED-ART DOCUMENTS

### Patent Documents

[Patent Document 1] Japanese Laid-open Patent Publication No. 2010-231609

### SUMMARY

According to an aspect of the embodiments, an electronic device includes an input apparatus including an input manipulation surface that receives a contact manipulation; a display part configured to display a pointer that moves in response to the contact manipulation; and a controlling part configured to generate a natural vibration in an ultrasound frequency band in the input manipulation surface. The controlling part varies an amplitude of the natural vibration in accordance with a positional change of the pointer on the display part to report a motion of the pointer on the display part.

### BRIEF DESCRIPTION OF DRAWINGS

FIG. 1A is a perspective view illustrating an electronic device according to an embodiment;

FIG. 1B is a perspective view illustrating an input apparatus used in the electronic device;

FIG. 2 is a diagram illustrating the input apparatus of the embodiment in plan view;

FIG. 3 is a diagram illustrating a cross-sectional view of the input apparatus taken along a line A-A of FIG. 2;

FIG. 4A is a diagram illustrating a standing wave generated in a top panel by a natural vibration in an ultrasound frequency band;

FIG. 4B is a diagram illustrating the standing wave generated in the top panel by the natural vibration in the ultrasound frequency band;

FIG. 5A is a diagram illustrating a case where a kinetic friction force applied to a fingertip performing a manipulation input varies in accordance with presence/absence of the natural vibration in the ultrasound frequency band generated in the top panel;

FIG. 5B is a diagram illustrating a case where the kinetic friction force applied to the fingertip performing the manipulation input varies in accordance with presence/absence of the natural vibration in the ultrasound frequency band generated in the top panel;

FIG. 6 is a diagram illustrating a configuration of the electronic device according to the embodiment;

FIG. 7A is a diagram illustrating first data stored in a memory;

FIG. 7B is a diagram illustrating second data stored in the memory;

FIG. 8 is a flowchart illustrating processing executed by a drive controlling part of the electronic device according to the embodiment;

FIG. 9 is a diagram illustrating an example of an operation of the electronic device according to the embodiment;

FIG. 10 is a diagram illustrating an example of an operation of the electronic device according to the embodiment;

FIG. 11 is a diagram illustrating an example of an operation of the electronic device according to the embodiment;

FIG. 12 is a diagram illustrating an example of an operation of the electronic device according to the embodiment;

FIG. 13 is a diagram illustrating an example of an operation of the electronic device according to the embodiment; and

FIG. 14 is a diagram illustrating an example of an operation of the electronic device according to the embodiment.

### DESCRIPTION OF EMBODIMENT

In the following, an input apparatus and an electronic device using the input apparatus according to an embodiment of the present invention are described. In the embodiment, tactile sensations, which differ in accordance with a motion of a pointer on a display screen, are given to a user, who performs a contact manipulation on the input apparatus, such that the user can grasp which part is manipulated on the screen without visual observation. For example, when a specific icon on the screen is selected by the pointer or when the pointer strides over between a plurality of windows opened on the screen, specific tactile sensations are given to the user such that the user can recognize a position of the pointer with the tactile sensations. According to an embodiment, it becomes possible to present a position of a pointer on a GUI to a user.

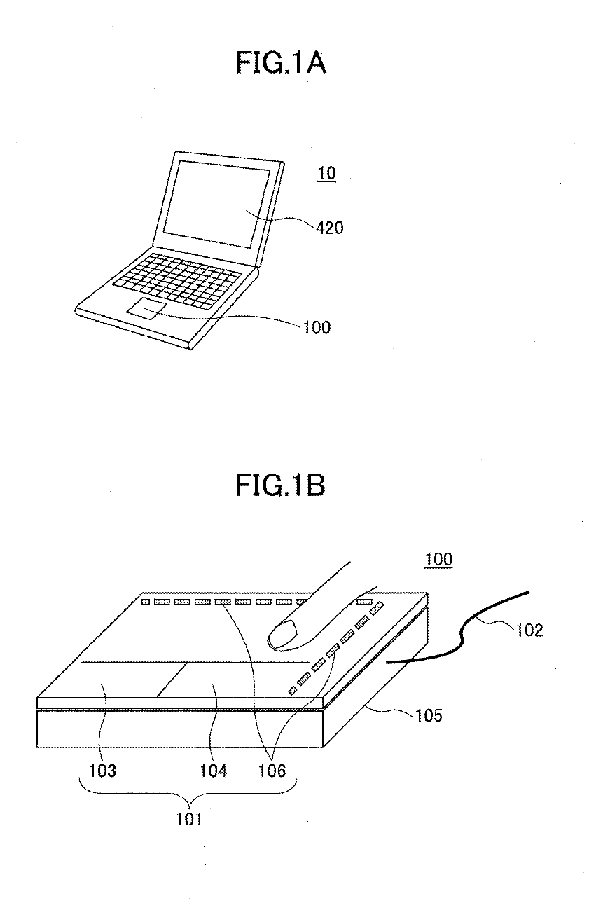

FIG. 1A illustrates a notebook personal computer (referred to as “PC” hereinafter) 10 as an example of an electronic device 10. The PC 10 includes a click pad 100 as an example of an input apparatus 100. The input apparatus 100 may be a device that has a smooth surface, which a user can touch, and has a sensor that can detect coordinates of a contact position. For example, the input apparatus 100 may be a mouse or a keyboard instead of the click pad 100. The PC 10 includes a display apparatus 420 to perform display in accordance with a manipulation on the click pad 100. For example, the display apparatus 420 is a display panel 420 such as a liquid crystal display panel or an organic Electroluminescence (EL) panel. The display panel 420 is driven and controlled by a driver Integrated Circuit (IC), which will be described later, and displays a GUI manipulation part, an image, characters, symbols, graphics or the like in accordance with an operating state of the electronic device 10.

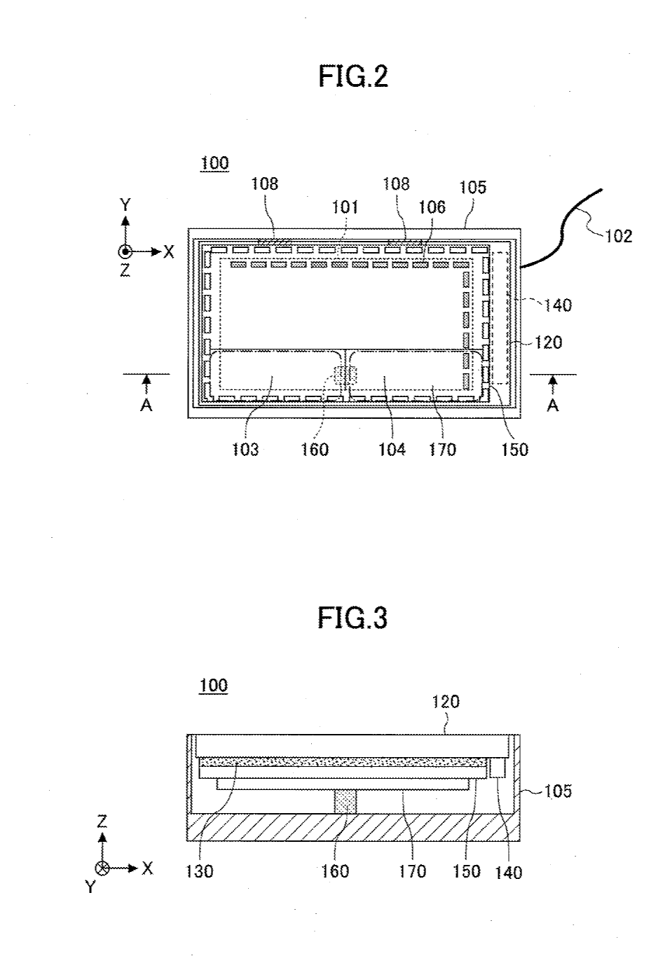

FIG. 1B is a perspective view of the click pad 100. FIG. 2 is a plan view of the click pad 100. FIG. 3 is a cross-sectional view of the click pad 100 taken along a line A-A of FIG. 2. The click pad 100 includes an input manipulation part 101 on a housing 105. A wire 102 is connected to a substrate 170 (see FIGS. 2 and 3) inside of the housing 105. The wire 102 connects the click pad 100 to a body of the PC 10.

A touch panel 150 is arranged on a back face of the input manipulation part 101 via an adhesive material 130 (see FIGS. 2 and 3). The touch panel 150 can detect contact with the surface of the input manipulation part 101. Depending on areas, various functions are allocated to the input manipulation part 101 by control software. For example, a touch operation can be performed on an entire surface of the input manipulation part 101. Tapping or pressing an area 103 corresponds to a left click of the mouse. Tapping or pressing an area 104 corresponds to a right click of the mouse. In this meaning, the area 103 is referred to as the “left button area 103” and the area 104 is referred to as the “right button area 104”. A scroll area 106 is disposed along a short side and a long side of the input manipulation part 101 in the example of FIG. 1B. A contact manipulation to the input manipulation part 101 is transmitted to the body of the PC 10 through the wire 102. A result in accordance with the input manipulation is received from the PC 10.

As illustrated in FIGS. 2 and 3, the click pad 100 includes a top panel 120, a vibrating element 140, the touch panel 150, a button 160, and the substrate 170 disposed inside of the housing 105. In this example, the top panel 120 is a thin plate-shaped member. A planar shape of the top panel 120 is a rectangular shape. A material of the top panel 120 is an arbitrary material that can use the touch panel 150 to detect coordinates of a finger touching the top panel 120 and can be driven at a natural vibration frequency in an ultrasound frequency band. In a case where a capacitance type touch panel is used as the touch panel 150, the top panel 120 is made of a transparent glass or a reinforced plastic such as polycarbonate. The vibrating element 140 is arranged on a back face (face on negative side in z axis direction) of the top panel 120. Another panel, a protection film, or the like may be provided on the surface of the top panel 120 as long as the top panel 120 protects the surface of the touch panel 150 and does not disturb the contact detection by the touch panel 150 and driving by the ultrasound wave.

The top panel 120 vibrates when the vibrating element 140 is driven. In the embodiment, a standing wave is generated in the top panel 120 by causing the top panel 120 to vibrate at a natural resonance frequency of the top panel 120. The natural resonance frequency of the top panel 120 is determined in consideration of a weight of the vibrating element 140 bonded on the top panel 120 or the like.

The vibrating element 140 may be any element as long as it can generate vibration in an ultrasound frequency band. An element including a piezoelectric element such as a piezo element may be used as the vibrating element 140, for example. The vibrating element 140 is driven by a driving signal output from a drive controlling part which will be described later. A frequency and an amplitude (intensity) of the vibration generated by the vibrating element 140 are set by the driving signal. An on/off action of the vibrating element 140 is controlled by the driving signal.

The ultrasound frequency band is a frequency band that is higher than or equal to about 20 kHz, for example. According to the click pad 100 of the embodiment, the frequency at which the vibrating element 140 vibrates is equal to a number of vibrations per unit time (frequency) of the top panel 120. Accordingly, the vibrating element 140 is driven in accordance with the driving signal so that the vibrating element 140 vibrates at a number of natural vibrations per unit time (natural vibration frequency) of the top panel 120.

The touch panel 150 may be a coordinate detector that can detect a contact position of the user on the top panel 120. The touch panel 150 may be a capacitance type coordinate detector or a resistance film type coordinate detector, for example. Alternatively, a coordinate detector using a camera, or an optical touch panel may be used. In the latter case, the touch panel 150 is arranged above the top panel 120. Hereinafter, the capacitance type coordinate detector is used as the touch panel 150. In a case where the touch panel 150 is a capacitance type, the touch panel 150 can detect a manipulation input performed on the top panel 120 even if there is a clearance gap between the touch panel 150 and the top panel 120.

The substrate 170 is disposed inside of the housing 105 via holders 108 and the button 160. The touch panel 150 and the cover glass 120 are arranged on the substrate 170. The button 160 is arranged below the substrate 170 as a dome switch, for example. When the top panel 120 is pushed, the substrate 170, the touch panel 150, and the top panel 120 are bent about the holders 108. When a distance to a bottom face of the housing 105 is reduced, an input determination is performed depending on the button push. On the substrate 170, a drive controlling apparatus which will be described hereinafter and various circuits or the like that are necessary for driving the click pad 100 are mounted.

In the click pad 100 having the configuration as described above, when the user touches the top panel 120 with the finger and a movement of the fingertip is detected, a drive controlling part mounted on the substrate 170 drives the vibrating element 140 to vibrate the top panel 120 at a frequency in the ultrasound frequency band. The frequency in the ultrasound frequency band is a resonance frequency of a resonance system including the top panel 120 and the vibrating element 140. A standing wave is generated in the top panel 120 at the frequency.

Vibrations having different pattern(s) are generated in the top panel 120 of the click pad 100 in accordance with movements or positions of the pointer on the display panel 420. Thereby, it becomes possible to allow the user who manipulates the click pad 100 to recognize, with the tactile sensations, the manipulation being executed.

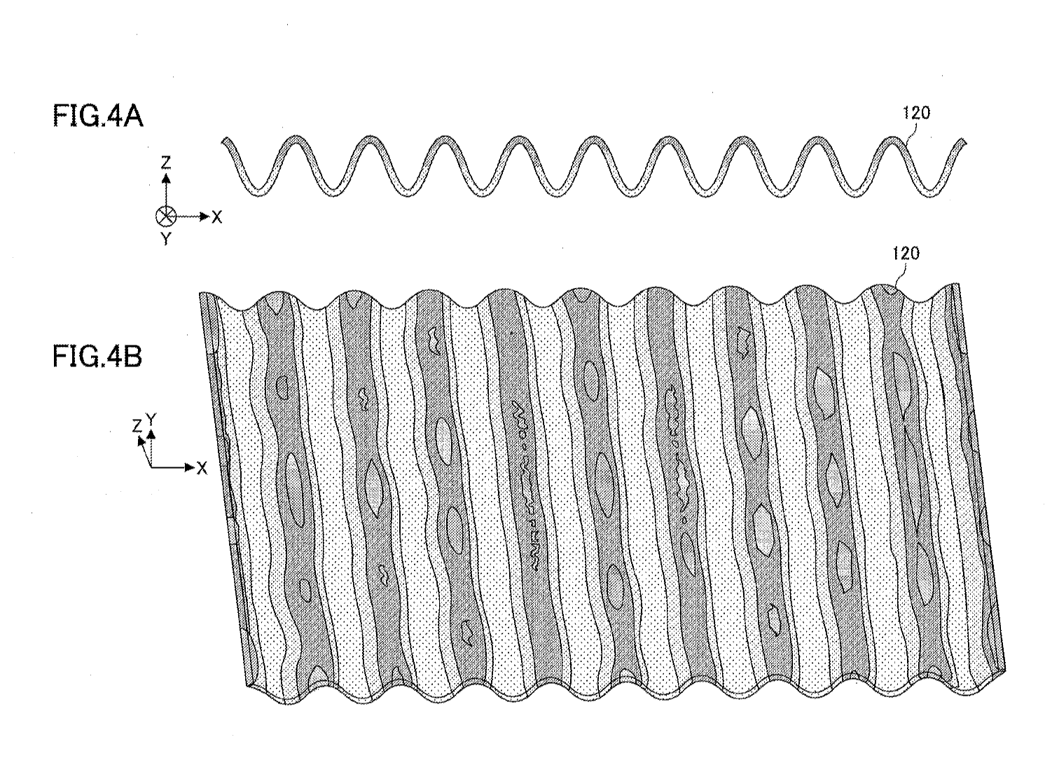

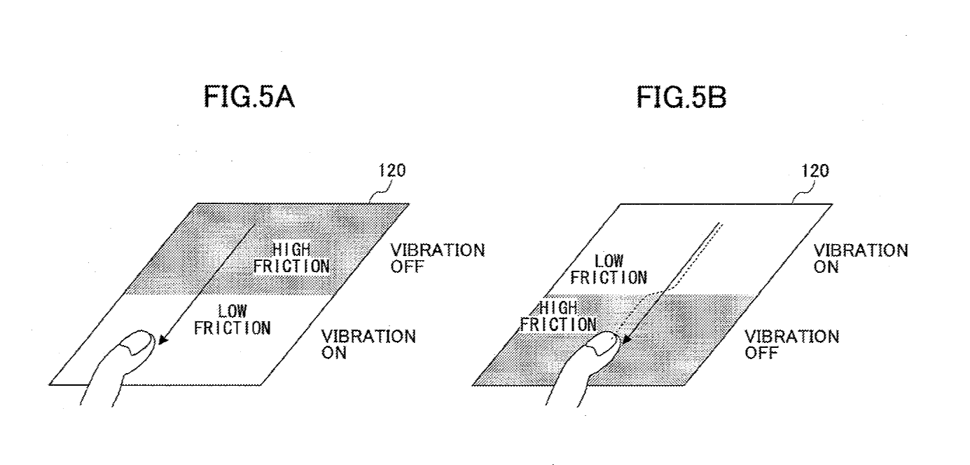

FIGS. 4A and 4B are diagrams that describe the standing wave generated in the top panel 120. In FIGS. 4A and 4B, the standing wave forming crests of the wave in parallel with the short side of the top panel 120 is generated by the natural vibration in the ultrasound frequency band is generated. FIG. 4A illustrates a side view, and FIG. 4B illustrates a perspective view. A XYZ coordinate system similar to that described in FIGS. 2 and 3 is defined.

The natural vibration frequency (the resonance frequency) f of the top panel 120 is represented by formulas (1) and (2) where E is the Young's modulus of the top panel 120, p is the density of the top panel 120, 5 is the Poisson's ratio of the top panel 120, 1 is the long side dimension of the top panel 120, t is the thickness of the top panel 120, and k is a periodic number of the standing wave along the direction of the long side of the top panel 120.

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

Because the standing wave has the same waveforms in every half cycle, the periodic number k takes values at 0.5 intervals. The periodic number k takes 0.5, 1, 1.5, 2 . . . . The coefficient α included in formula (2) corresponds to coefficients other than k² included in formula (1).

A waveform of the standing wave as illustrated in FIGS. 4A and 4B is obtained in a case where the periodic number k is 10, for example. In a case where a sheet of Gorilla (registered trademark) glass of which the length 1 of the long side is 140 mm, the length of the short side is 80 mm, and the thickness t is 0.7 mm is used as the top panel 120, for example, the natural vibration number f is 33.5 kHz, if the periodic number k is 10. In this case, a frequency of the driving signal is 33.5 kHz.

The top panel 120 is a flat member. If the vibrating element 140 (see FIGS. 2 and 3) is driven and the natural vibration in the ultrasound frequency band is generated in the top panel 120, the top panel 120 is bent as illustrated in FIGS. 4A and 4B. As a result, the standing wave is generated in the surface of the top panel 120.

Although an example of a configuration is described in which the single vibrating element 140 is arranged, on the back face (a negative side face in z axis direction) of the top panel 120, along one of the short sides (y axis direction), two vibrating elements 140 may be used. In a case where the two vibrating elements 140 are used, another vibrating element 140 may be bonded along the other of the short sides of the top panel 120. In this case, the two vibrating elements 140 may be axisymmetrically disposed with respect to a center line of the top panel 120 parallel to the two short sides of the top panel 120. In a case where the two vibrating elements 140 are driven, the two vibrating elements 140 may be driven in the same phase, if the periodic number k is an integer number. If the periodic number k is an odd number, the two vibrating elements 140 may be driven in opposite phases.

FIGS. 5A and 5B are diagrams describing effects of the natural vibration in the ultrasound frequency band generated in the top panel 120 of the click pad 100. When the natural vibration in the ultrasound frequency band is generated or stopped in the top panel 120 of the click pad 100, a kinetic friction force applied to the fingertip of the user, who performs the manipulation input, varies.

In FIGS. 5A and 5B, the user moves the finger in a direction of the arrow to perform a manipulation or an input while touching the top panel 120 with the fingertip. An on/off state of the vibration during movement of the user's finger is switched by switching an on/off state of the vibrating element 140 (see FIGS. 2 and 3). In FIGS. 5A and 5B, areas which the fingertip touches while the vibration is turned off are indicated in grey and areas which the fingertip touches while the vibration is turned on are indicated in white.

In the operation pattern illustrated in FIG. 5A, the vibration is turned off when the user's finger is located on the far side of the top panel 120, and the vibration is turned on in the process of moving the finger toward the near side. In the operation pattern illustrated in FIG. 5B, the vibration is turned on when the user's finger is located on the far side of the top panel 120, and the vibration is turned off in the process of moving the finger toward the near side.

When the natural vibration in the ultrasound frequency band is generated in the top panel 120, a layer of air intervenes between the surface of the top panel 120 and the finger. The layer of air is provided by a squeeze film effect. As a result, a kinetic friction coefficient when the user traces the surface of the top panel 120 with the finger is decreased. Accordingly, in the grey area located on the far side of the top panel 120 illustrated in FIG. 5A, the kinetic friction force applied to the fingertip increases. In the white area located on the near side of the top panel 120, the kinetic friction force applied to the fingertip decreases.

The user who is performing the manipulation input in a direction of the arrow illustrated in FIG. 5A senses a reduction of the kinetic friction force applied to the fingertip when the vibration is turned on. As a result, the user senses slipperiness with the fingertip. In this case, the user feels as if a concave portion were present on the surface of the top panel 120 when the surface of the top panel 120 becomes slippery and the kinetic friction force decreases.

In FIG. 5B, the kinetic friction force applied to the fingertip decreases in the white area located on the far side of the top panel 120, and the kinetic friction force applied to the fingertip increases in the grey area located on the near side of the top panel 120. The user who is performing the manipulation input in a direction of the arrow illustrated in FIG. 5B senses an increase of the kinetic friction force applied to the fingertip when the vibration is turned off. As a result, the user senses a grippy or scratchy touch (texture) with the fingertip. In this case, the user senses as if a convex portion were present on the surface of the top panel 120 when the fingertip becomes grippy and the kinetic friction force increases.

According to the above described configuration, the user can sense a concavity or convexity with the fingertip in the cases as illustrated in FIGS. 5A and 5B. For example, “The Printed-matter Typecasting Method for Haptic Feel Design and Sticky-band Illusion” (the Collection of papers of the 11th SICE system integration division annual conference (SI2010, Sendai) 174-177, 2010-12) discloses that a human can sense a concavity or a convexity. “Fishbone Tactile Illusion” (Collection of papers of the 10th Congress of the Virtual Reality Society of Japan (September, 2005)) discloses that a human can sense a concavity or a convexity as well.

Although a variation of the kinetic friction force when the on/off of the vibration is switched is described in the above described example, similar effects are obtained when the amplitude (intensity) of the vibrating element 140 is varied.

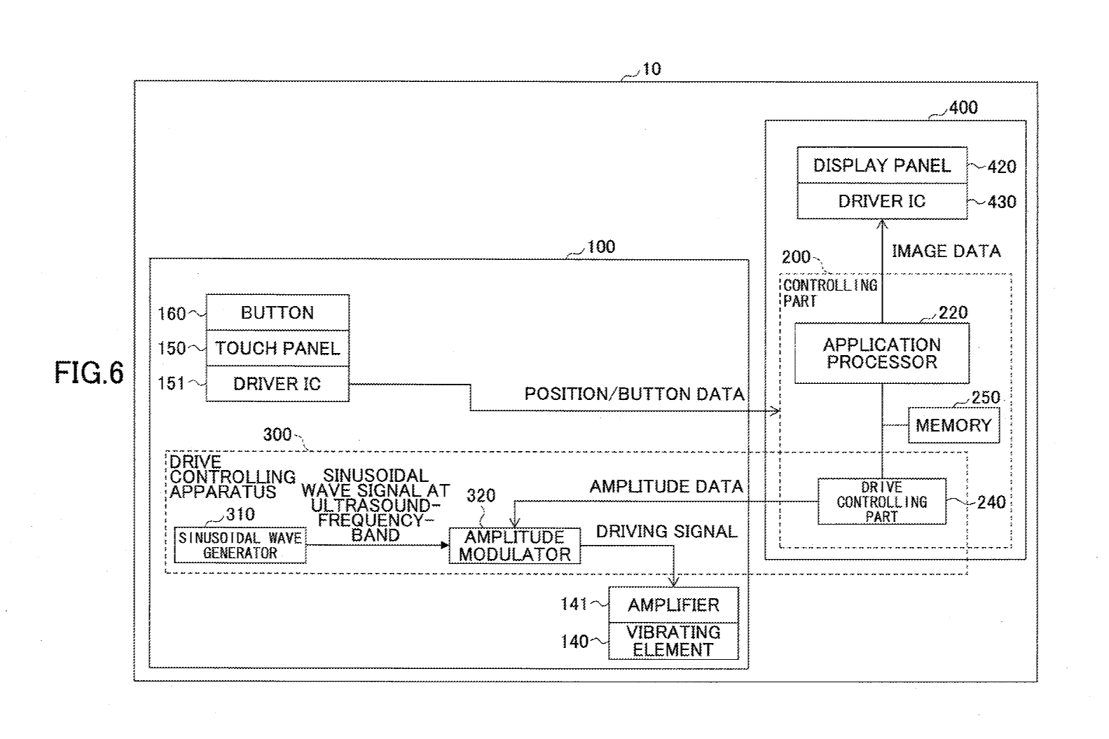

FIG. 6 is a block diagram illustrating a configuration of the electronic device (PC) 10. The electronic device 10 includes the click pad 100 as the input apparatus, a drive controlling apparatus 300, and a PC body 400. The click pad 100 includes the vibrating element 140, an amplifier 141, the touch panel 150, a driver Integrated Circuit (IC) 151, and the button 160. The amplifier 141 is disposed between the drive controlling apparatus 300 and the vibrating element 140. The amplifier 141 amplifies the driving signal output from the drive controlling apparatus 300 and drives the vibrating element 140. In FIG. 6, the holders 108, the housing 105, the top panel 120, and the like are omitted. The drive controlling apparatus 300 includes a sinusoidal wave generator 310, an amplitude modulator 320, and a drive controlling part 240. Although the drive controlling apparatus 300 is arranged across the click pad 100 and the PC body 400, the drive controlling apparatus 300 may be arranged on either the click pad 100 or the PC body 400. All or part of the amplifier 141, the driver IC 151, the sinusoidal wave generator 310, and the amplitude modulator 320 of the click pad 100 may be arranged in the PC body 400.

The PC body 400 includes a controlling part 200, the display panel (display part) 420, and a driver IC 430. The controlling part 200 includes an application processor 220, the drive controlling part 240 and a memory 250. The controlling part 200 is realized by an IC chip, for example.

The controlling part 200 of the PC body 400 transmits/receives a signal to/from the amplitude modulator 320 of the drive controlling apparatus 300 and the driver IC 151 of the click pad 100. The transmission/reception of the signal may be performed via the wire 102 (see FIG. 1) or may be performed wirelessly. The display panel 420 is driven and controlled by the driver IC 430 and displays the GUI manipulation part, an image, characters, symbols, graphics or the like in accordance with an operating state of the click pad 100.

Although the application processor 220, the drive controlling part 240 and the memory 250 are realized by the single controlling part 200, the drive controlling part 240 may be disposed outside of the controlling part 200 and realized by another IC chip or a processor. In this case, data which is necessary for a drive control performed by the drive controller 240 among data stored in the memory 250 may be stored in another memory disposed in the drive control apparatus 300.

Next, generation of the vibration in accordance with the input manipulation is described.

The driver IC 151 is connected to the touch panel 150 and the button 160. The driver IC 151 detects position data representing the position on the touch panel 150 where the manipulation input is performed. The detected position data is output to the controlling part 200. In a case where an input to the button 160 is present, the driver IC 151 uses the position data detected by the touch panel to determine which area is manipulated in the input manipulation part 101 (see FIG. 1B) and to determine whether the button input is performed. The driver IC 151 outputs a determination result to the controlling part 200. These position data are input to the application processor 220 and the drive controlling part 240. Inputting the position data to the drive controlling part 240 is equal to inputting the position data to the drive controlling apparatus 300.

The driver IC 430 is connected to the display panel 420. The driver IC 430 inputs image data output from the application processor 220 to the display panel 420 and displays an image on the display panel 420 based on the image data. The application processor 220 performs processing for executing various applications of the electronic device 10. The display panel 420 displays the GUI manipulation part, the image or the like based on the image data generated by the application processor 220.

In a case where two designated conditions are satisfied, the drive controlling part 240 outputs amplitude data to the amplitude modulator 320. The two conditions are (1) The moving speed of the user's finger becomes equal to or greater than a designated threshold, and (2) The position of the fingertip performing the manipulation input is located in a designated area that requires generating the vibration when the vibration is generated.

The amplitude data represents an amplitude value for controlling an intensity of the driving signal used to drive the vibrating element 140. The amplitude value is set in accordance with a temporal change degree of the position data. A moving speed of the user's fingertip tracing along the surface of the top panel 120 is used as the temporal change degree of the position data. The drive controlling part 240 calculates the moving speed of the user's fingertip based on an amount of temporal change of the position data input from the driver IC 151.

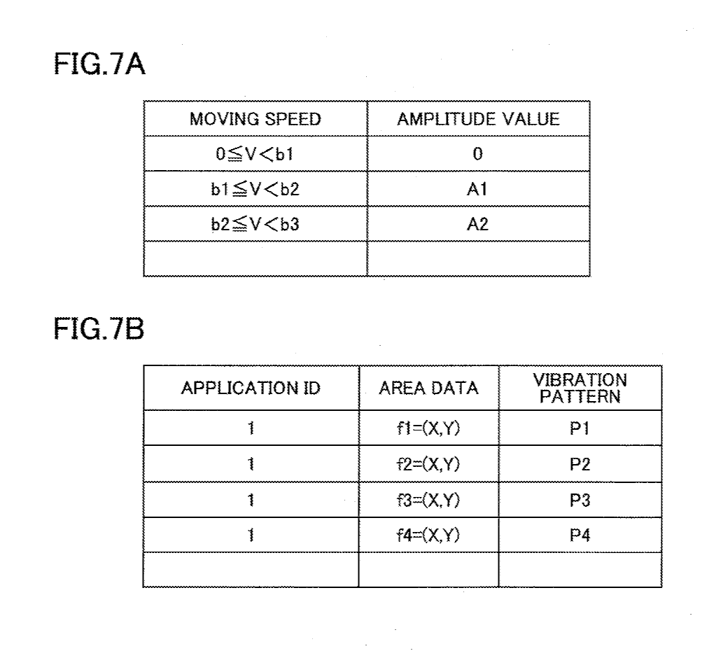

The higher the moving speed becomes, the smaller the drive controlling apparatus 300 controls the amplitude value to be, for the sake of making the tactile sensation sensed by the user constant regardless of the moving speed of the fingertip, for example. The lower the moving speed becomes, the greater the drive controlling apparatus 300 controls the amplitude value to be, for the sake of making the tactile sensation constant regardless of the moving speed of the fingertip, for example. The relationship between the amplitude value and the moving speed is stored in the memory 250 as first data (table) illustrated in FIG. 7A. Instead of storing in advance the table representing the relationship between the amplitude value and the moving speed, the amplitude value A may be calculated by using formula (3). Similar to the first data, the higher the moving speed becomes, the smaller the amplitude value A calculated by formula (3) becomes. The lower the moving speed becomes, the greater the amplitude value A calculated by formula (3) becomes.

A=A₀/\sqrt{|V|/a} (3)

“A₀” is a reference value of the amplitude, “V” represents the moving speed of the fingertip and “a” is a designated constant value. In a case where the amplitude value A is calculated by using formula (3), data representing formula (3) and formula (3) (including the reference value A₀ and the designated constant value a) may be stored in the memory 250.

The drive controlling apparatus 300 of the embodiment causes the top panel 120 to vibrate in order to vary the kinetic friction force applied to the user's fingertip when the fingertip traces along the surface of the top panel 120. Because the kinetic friction force occurs when the fingertip is moving, the drive controlling part 240 vibrates the vibrating element 140 when the moving speed becomes equal to or greater than the designated threshold speed. When the moving speed becomes equal to or greater than the designated threshold speed, the above described condition (1) is satisfied.

The amplitude value of the amplitude data output from the drive controlling part 240 becomes zero in a case where the moving speed is less than the designated threshold speed. The amplitude value is set to a different amplitude value corresponding to the moving speed in a case where the moving speed is greater than or equal to the designated threshold speed. In a case where the moving speed is greater than or equal to the designated threshold speed, the higher the moving speed becomes, the smaller the amplitude value becomes. In a case where the moving speed is greater than or equal to the designated threshold speed, the lower the moving speed becomes, the greater the amplitude value becomes.

In a case where the moving speed is less than the designated threshold speed, the amplitude value is set to zero based on condition (1). This is because it is difficult to vary the kinetic friction force in a case where the user's fingertip does not move, even when the vibrating element 140 is vibrated. Accordingly, it is unnecessary to set the amplitude value to zero in a case where condition (2) is satisfied and there is no problem with consumption current or the like.

Next, condition (2) is described. The drive controlling apparatus 300 outputs the amplitude data to the amplitude modulator 320 in a case where the position of the fingertip performing the manipulation input is within a designated area which requires generating the vibration. The drive controlling apparatus 300 determines whether the position of the fingertip performing the manipulation input is within the designated area which requires generating the vibration based on the position information on the fingertip performing the manipulation input.

A position of a GUI manipulation part, an image display area, an area representing an entire page, or the like displayed on the display panel 420 is specified by the area data representing the area. In all applications, the area data is provided for all GUI manipulation parts, image display areas, or areas representing entire pages.

Accordingly, when it is determined in condition (2) whether the position of the fingertip performing the manipulation input is within the designated area which requires generating the vibration, a kind of the application activated by the electronic device 10 is related to the determination. This is because displaying on the display panel 420 differs depending on the kind of the applications.

The kind of the manipulation inputs differs depending on the kind of the applications. There is a so-called flick operation as a kind of the manipulation input performed by tracing the fingertip(s) touching the surface of the top panel 120, for example. The flick operation is performed when manipulating the GUI manipulation part, for example. The flick operation is performed by flicking (snapping) the surface of the top panel 120 for a relatively-short distance with the fingertip.

In addition, there is a swipe operation. The swipe operation is performed by swiping the surface of the top panel 120 for a relatively-long distance with the fingertip. The swipe operation is performed, in an application for displaying photos with movements of the mouse pointer or the display panel 420, in a case where the user turns over a photo to display the next photo, for example. In a case where the user selects and moves an icon or slides a slider by the GUI manipulation part, a drag operation is performed to drag the icon or the slider.

The manipulation input performed by moving the fingertip along the surface of the top panel 120, such as the flick operation, the swipe operation or the drag operation, is differently used depending on a kind of displaying by an application. Accordingly, when it is determined whether the position of the fingertip performing the manipulation input is within the designated area which requires generating the vibration, a kind of the applications actuated by the electronic device 10 is related to the determination.

A correspondence relationship between the kind of the applications, the area data representing the area in which the manipulation input is performed, and the vibration pattern is stored in the memory 250 as second data (table) illustrated in FIG. 7B.

The drive controlling part 240 uses the area data in the memory 250 to determine whether the position represented by the position data supplied from the driver IC 151 is located in the designated area which requires generating the vibration.

The drive controlling part 240 performs the following processes in order to interpolate a positional change of the position of the fingertip. The positional change arises in a period of time required from a point in time when the position data is input to the drive controlling apparatus 300 from the driver IC 151 to a point in time when the driving signal is calculated based on the input position data.

The drive controlling apparatus 300 performs calculation every designated control cycle. The drive controlling part 240 performs calculation every designated control cycle as well. Supposing that the period of time required from the point in time when the position data is input to the drive controlling apparatus 300 from the driver IC 151 to the point in time when the driving signal is calculated by the drive controlling part 240 based on the position data is Δt, the required period of time Δt is equal to a period of the control cycle.

It is possible to calculate the moving speed of the fingertip as a velocity of a vector which has a starting point (x1, y1) represented by the position data input to the drive controlling apparatus 300 from the driver IC 151 and a terminal point (x2, y2) corresponding to the position of the fingertip after a lapse of the required period of time Δt.

The drive controlling part 240 interpolates the positional change of the fingertip in the period of time Δt by estimating a coordinate point (x3, y3) after a lapse of the required period of time Δt by calculating a vector having a starting point (x2, y2) represented by the position data input to the drive controlling apparatus 300 from the driver IC 151 and a terminal point (x3, y3) corresponding to the position of the fingertip after the lapse of the required period of time Δt.

The drive controlling part 240 determines whether the estimated coordinate point after the lapse of the required period of time Δt is located in the designated area that requires generating the vibration and generates the vibration in a case where it is located in the designated area that requires generating the vibration.

In a case where the moving speed of the fingertip is greater than or equal to the designated threshold speed and the estimated coordinate point is located in the designated area that requires generating the vibration, the drive controlling part 240 reads the amplitude data, representing the amplitude value in accordance with the moving speed, from the memory 250 to output the amplitude data to the amplitude modulator 320.

The sinusoidal wave generator 310 generates sinusoidal waves used for generating the driving signal which causes the top panel 120 to vibrate at the natural vibration frequency. For example, in a case of causing the top panel 120 to vibrate at 33.5 kHz of the natural vibration frequency f, a frequency of the sinusoidal waves becomes 33.5 kHz. The sinusoidal wave generator 310 inputs a sinusoidal wave signal in the ultrasound frequency band to the amplitude modulator 320. The sinusoidal wave generator 310 inputs a sinusoidal wave signal in the ultrasound frequency band to the amplitude modulator 320.

The amplitude modulator 320 generates the driving signal by modulating an amplitude of the sinusoidal wave signal input from the sinusoidal wave generator 310 based on the amplitude data input from the drive controlling part 240. The amplitude modulator 320 modulates only the amplitude of the sinusoidal wave signal in the ultrasound frequency band input from the sinusoidal wave generator 310 and does not modulate a frequency and a phase of the sinusoidal wave signal in order to generate the driving signal. In a case where the amplitude data is zero, the amplitude of the driving signal becomes zero. This is the same as the amplitude modulator 320 not outputting the driving signal.

FIG. 7A illustrates an example of the first data stored in the memory 250. FIG. 7B illustrates an example of second data. In the example in FIG. 7A, different amplitude values (0, A1, A2) are set in accordance with the moving speed V of the finger. In the example in FIG. 7B, the application ID (Identification) is illustrated as the data representing the kind of the application. The coordinate values (f1 to f4) of the areas, where the GUI manipulation parts or the like on which the manipulation inputs are performed are displayed, are stored as associated area data. P1 to P4 are stored as the vibration patterns associated with the area data.

The applications included in the second data may include any applications available in an apparatus in which an input apparatus does not serve as a display screen. For example, the applications may include an editing mode of e-mail.

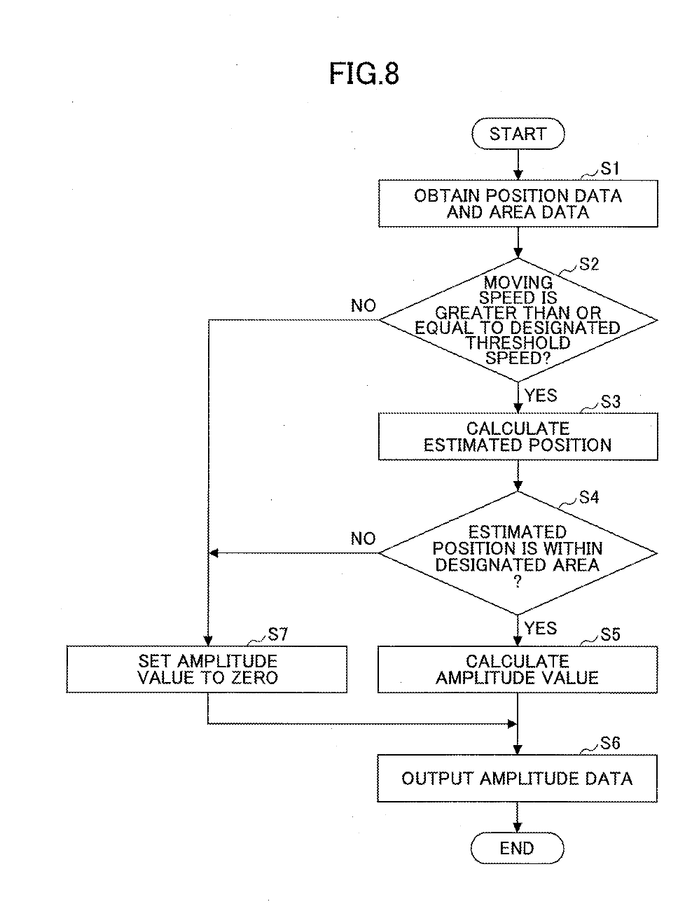

FIG. 8 is a flowchart illustrating processing executed by the drive controlling part 240 of the drive controlling apparatus 300. An operating system (OS) of the electronic device 10 executes control for driving the electronic device 10 with respect to every designated control cycle. Thus, the drive controlling apparatus 300 performs calculation with respect to every designated control cycle. The drive controlling part 240 repeatedly executes the processing flow of FIG. 8 in the designated control cycle as well.

As described above, a period of time of one cycle of the control cycle can be treated as the required period of time Δt which is required from the point in time when the position data is input to the drive control apparatus 300 from the driver IC 151 to the point in time when the driving signal is calculated based on the input position data.

The drive controlling part 240 starts the processing when the electronic device 10 is turned on. The drive controlling part 240 obtains current position data and area data (step S1). The area data is obtained with respect to a function allocated to the GUI on which the manipulation input is being performed currently in accordance with the coordinates represented by the position data and the kind of the current application. The area data is associated with the vibration pattern as illustrated in FIG. 7B.

The drive controlling part 240 determines whether the moving speed is greater than or equal to the designated threshold speed (step S2). The moving speed may be calculated by a vector operation. The threshold speed may be set to the minimum speed of the moving speed of the fingertip when the manipulation input such as the flick operation, the swipe operation, the drag operation, or the like is performed while the fingertip is moved. Such a minimum speed may be set based on an experimental result, a resolution capability of the touch panel 150, or the like.

The drive controlling part 240 calculates the estimated coordinate point after a lapse of the required period of time Δt based on the coordinate point represented by the present position data and the moving speed (step S3), in a case where the drive controlling part 240 has determined at step S2 that the moving speed is greater than or equal to the designated threshold speed.

The drive controlling part 240 determines at step S4 whether the estimated coordinate point after the lapse of the required period of time Δt is within an area represented by the area data calculated at step S1. In a case where the estimated coordinate point after the lapse of the required period of time Δt is within the area represented by the area data, the drive controlling part 240 calculates the amplitude value corresponding to the moving speed calculated at step S2 from the first data of FIG. 7A (step S5).

The drive controlling part 240 outputs the amplitude data (step S6). Thereby, the amplitude modulator 320 modulates the amplitude of the sinusoidal wave output from the sinusoidal wave generator 310 to generate the driving signal, and the vibrating element 140 is driven.

In contrast, in a case where the moving speed is not greater than or equal to the designated threshold speed (no at step S2) or in a case where the estimated coordinate point after the lapse of the required period of time Δt is not located in the area represented by the area data calculated at step S1 (no at step S4), the drive controlling part 240 sets the amplitude value to zero (step S7).

As a result, the drive controlling part 240 outputs the amplitude data of which the amplitude value is zero, and the amplitude modulator 320 generates the driving signal by modulating the amplitude of the sinusoidal wave output from the sinusoidal wave generator 310 to zero. Accordingly, in this case, the vibrating element 140 is not driven.

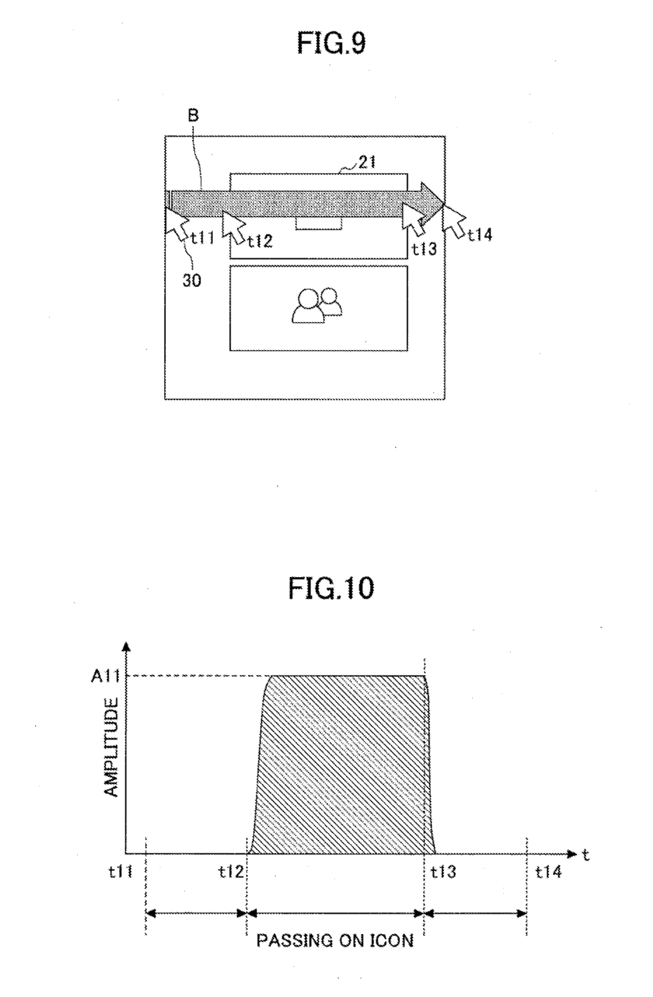

In the following, specific examples of the operation of the electronic device 10 according to the embodiment are described with reference to FIGS. 9 to 14.

### Working Example 1

FIG. 9 illustrates a motion of a pointer 30 passing over an icon 21 to a direction of an arrow B in the GUI displayed on the display panel 420 when the user performs a swipe input on the input manipulation part 101 of the click pad 100. The manipulation of the pointer 30 is started at a time t11. The pointer 30 enters into an area of the icon 21 at a time t12, comes out of the area of the icon 21 at a time t13, and the manipulation of the pointer 30 ends at a time t14.

In this way, the drive controlling part 240 determines whether the pointer 30 is within the area of the icon 21 in the operation mode of the pointer 30 passing over an object such as the icon 21.

FIG. 10 illustrates the amplitude data output from the drive controlling part 240 in a case where the manipulation input illustrated in FIG. 9 is performed. In FIG. 10, a horizontal axis represents time, and a vertical axis represents the amplitude value of the amplitude data. The sinusoidal wave generated by the sinusoidal wave generator 310 is modulated in the amplitude modulator 320 using the amplitude data of FIG. 10 and the driving signal for driving the vibrating element 140 is output.

When the pointer 30 enters into the area of the icon 21 at the time t12, the amplitude rises to A11 and is maintained substantially constant. Here, it is supposed that the moving speed of the fingertip when the user performs the swipe operation is substantially constant. When the pointer 30 comes out of the area on the icon 21 at the time t13, the drive controlling part 240 sets the amplitude value to zero. Accordingly, the amplitude becomes zero right after the time t13.

As a result of the drive control, the kinetic friction force applied to the user's fingertip decreases and a slipping sensation is provided to the user's fingertip while the pointer 30 is present on the icon 21 during the swipe operation of the user. The user can feel with the fingertip that the pointer 30 is present on the icon 21 without staring the screen.

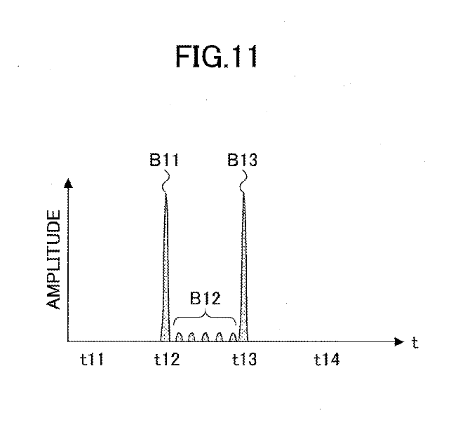

In the example of FIG. 9 where the pointer 30 passes over the icon 21, vibration patterns of FIG. 11 may be used instead of the vibration pattern of FIG. 10. In FIG. 11, a vibration B11 having a great amplitude over a short amount of time occurs at the time t12 when the pointer 30 reaches the icon 21. The vibration B11 provides, to the user, the tactile sensation of touching a projection with the fingertip by changing a condition from a low-friction-condition (great amplitude) over the short amount of time, which the user may not sense with the fingertip, to a high-friction-condition (drop of the amplitude to zero) instantaneously.

Between the time t12 and the time t13, vibrations B12 each having a small amplitude over a short amount of time occur at regular intervals while the fingertip moves inside of the icon 21 to the direction of the arrow B (right direction in a space). Thereby, a feel different from the feel given by the vibration pattern of FIG. 10 is provided to the user. When the pointer 30 comes out of the area of the icon 21 at the time t13, a vibration B13 having a great amplitude over a short amount of time is generated. The vibration B13 is similar to the vibration B11 and provides, to the user, the tactile sensation of touching a projection with the fingertip by changing a condition from a low-friction-condition over the short amount of time, which the user may not sense with the fingertip, to a high-friction-condition instantaneously. In this way, the user can feel that the pointer 30 has come out of the area of the icon 21.

A vibration waveform read from the memory 250 is changed in accordance with the application. Thereby, the user can grasp the manipulation of a specific icon with the tactile sensations. For example, in a case where a maximize box, a minimize box or a close box located at a corner of a window opened on the display panel 420 is selected by the swipe operation, the amplitude is increased when the pointer passes the vicinity of the box and the amplitude is maintained within the area of the icon and the vicinity of the icon. Thereby, the user can recognize the selection of the icon with the tactile sensations.

### Working Example 2

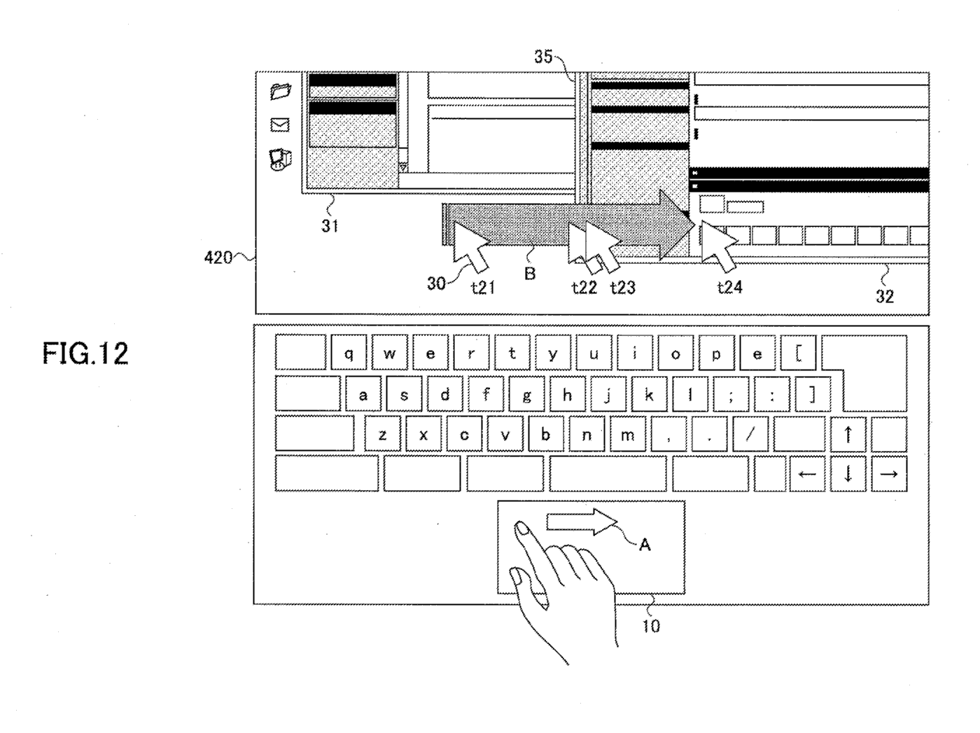

FIG. 12 illustrates a motion of the pointer 30 passing over a boundary of a window in the GUI displayed on the display panel 420 when the user performs the swipe input on the input manipulation part 101 of the click pad 100 in a direction of an arrow B.

A manipulation of the pointer 30 is started at a time t21 when a plurality of windows 31 and 32 are opened on the display panel 420. The pointer 30 enters into the vicinity of a boundary 35 of the window 32 at a time t22 and comes out of the vicinity of the window boundary 35 at a time t23. The manipulation of the pointer 30 ends at a time t24.

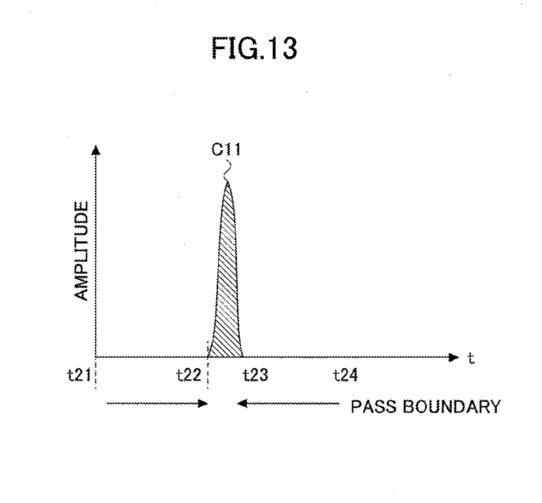

FIG. 13 illustrates the amplitude data output from the drive controlling part 240 in a case where the manipulation input of FIG. 12 is performed. In FIG. 13, a horizontal axis represents a time axis, and a vertical axis represents the amplitude value of the amplitude data. The sinusoidal wave generated by the sinusoidal wave generator 310 is modulated in the amplitude modulator 320 using the amplitude data of FIG. 13 and the driving signal for driving the vibrating element 140 is output. When the pointer 30 passes the boundary 35 of the window 32 between the time 22 and the time 23, a vibration C11 having a great amplitude over a short amount of time occurs. The vibration C11 provides, to the user, the tactile sensation of touching a projection with the fingertip by changing a condition from a low-friction-condition over the short amount of time, which the user may not sense with the fingertip, to a high-friction-condition instantaneously. Thereby, it becomes possible to provide a tactile sensation as crossing over a frame at the boundary 35 of the window 32 and to cause the user to recognize that the pointer 30 has crossed over the window.

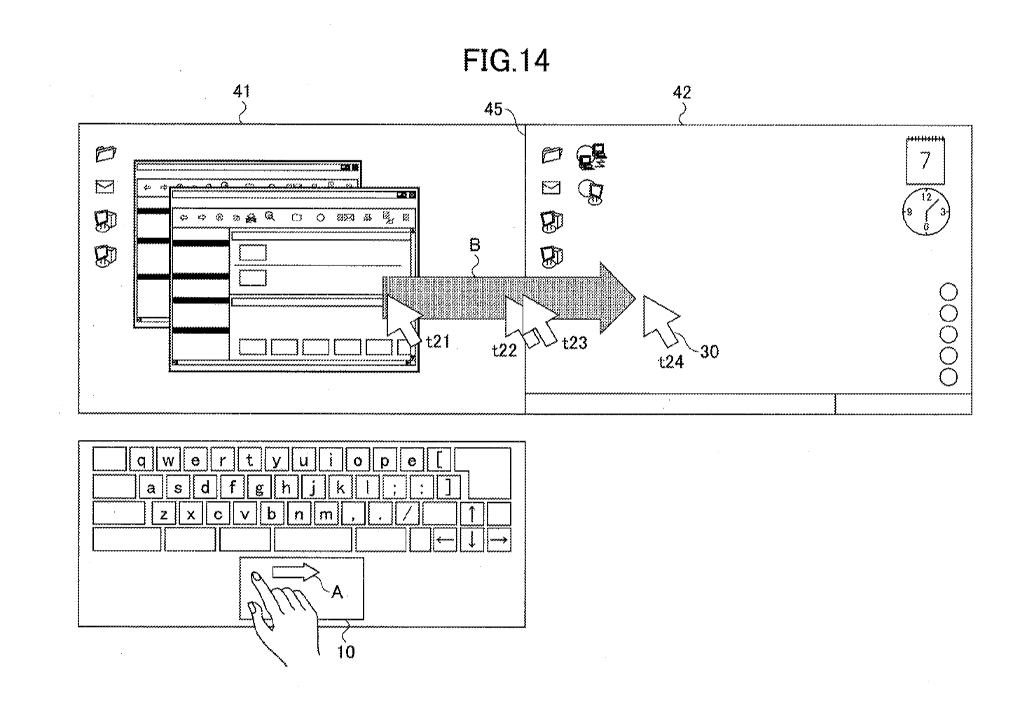

The vibration pattern of FIG. 13 can be applied not only to a case where the pointer crosses over the boundary of the window in the display panel as illustrated in FIG. 12, but also to a case where the pointer strides over between display panels of a multi-display as illustrated in FIG. 14. For example, when the user slides the finger on the input apparatus (click pad) 100 in a direction of an arrow A to move the pointer 30 in the direction of the arrow B from the display panel 41 to the display panel 42, the tactile sensation can be provided to the user's finger manipulating the click pad 100 as if the finger were crossing over a convex portion.

Specifically, the manipulation of the pointer 30 is started at a time t21, the pointer 30 enters into a boundary 45 between the display panels 41 and 42 at a time 22, and the pointer 30 comes out of the area of the boundary 45 at a time t23. The manipulation of the pointer 30 ends at a time t24. The vibration C11 illustrated in FIG. 13 is generated when the pointer 30 passes the boundary 45 between the display panels between the time t22 and the time 23. Thereby, it becomes possible to provide, to the user, the tactile sensation of touching the convex with the fingertip.

According to the above described electronic device 10 of the embodiment, the vibrations that differ in accordance with the manipulation position of the user and the application are generated in the surface of the input apparatus. Thereby, the user can recognize the manipulation being executed based on the tactile sensations.

Further, only the amplitude is modulated to generate the driving signal without modulating the frequency or the phase of the sinusoidal wave in the ultrasound frequency band generated by the sinusoidal wave generator 310. Thereby, it becomes possible to generate the natural vibration of the top panel 120 in the top panel 120. It becomes possible to reduce the kinetic friction coefficient with absolute certainty when the fingertip traces the surface of the top panel 120 by utilizing the layer of air provided by the squeeze film effect. It becomes possible to provide the fine tactile sensations to the user as if a concave portion and a convex portion were present on the surface of the top panel 120 by utilizing the Sticky-band Illusion effect or the Fishbone Tactile Illusion effect.

Further, the coordinate point after the lapse of the required period of time Δt corresponding to the period of time of one cycle of the control cycle is estimated, and the vibration is generated in a case where the estimated coordinate is located in the designated area which requires generating the vibration. Accordingly, it becomes possible to generate the vibrations while the fingertip is actually touching the designated GUI manipulation part or the like.

In a case where a delay corresponding to the required period of time Δt, corresponding to the period of time of one cycle of the control cycle, does not matter, the calculation of the estimated coordinate point does not have to be performed.

In the embodiment, the amplitude value of the driving signal is varied between the designated amplitude value and zero to switch on/off the vibrating element 140 in order to provide the tactile sensations to the user as if a concave portion and a convex portion were present on the top panel 120. However, instead of switching off the vibrating element 140, the amplitude may be decreased to switch the driving of the vibrating element 140. For example, the amplitude may be reduced to less than half to provide the tactile sensations to the user as if the concave portion and the convex portion were present on the top panel 120. It is preferable to reduce the amplitude to about one-fifth.

In this case, the vibrating element 140 is driven by the drive signal that switches the strength of the vibration of the vibrating element 140. As a result, the strength of the natural vibration generated in the top panel 120 is switched. It becomes possible to provide the sensations as if the user's fingertip were touching the concave portion and the convex portion.

As described above, the configurations and the methods of the present invention are described based on the specific examples. However, the present invention is not limited to these examples, but various variations and modifications may be made without departing from the scope of the present invention.

For example, amplitude patterns obtained by reversing the amplitude patterns illustrated in FIGS. 10, 11, and 13 may be used to notify the user of the selection or passing of the icon, or crossing over of the boundary of the window or the display panel with the tactile sensations.

Further, although the click pad of the notebook PC is described as an example of the input apparatus in the embodiment, the embodiment may be applicable to an arbitrary input apparatus in which a pointer displayed on a display panel can be manipulated by a contact input. For example, the embodiment may be applicable to an input apparatus having a smooth surface similar to a mouse pad.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the sprit and scope of the invention.

What is claimed is:

1. An electronic device comprising:
an input apparatus including an input manipulation surface that receives a contact manipulation;
a display part configured to display a pointer that moves in response to the contact manipulation; and
a controlling part configured to generate a natural vibration in an ultrasound frequency band in the input manipulation surface,
wherein the controlling part varies an amplitude of the natural vibration in accordance with a positional change of the pointer on the display part to report a motion of the pointer on the display part.

2. The electronic device as claimed in claim 1, wherein the controlling part varies the amplitude of the natural vibration when the pointer is located in or passes an area of a graphical user interface displayed on the display part.

3. The electronic device as claimed in claim 2,
wherein the controlling part varies the amplitude of the natural vibration at a timing when the pointer enters into an area of an icon displayed on the display part, and
wherein the controlling part maintains the amplitude at a constant value while the pointer is located in the area of the icon.

4. The electronic device as claimed in claim 2, wherein the controlling part gives a first variation to the amplitude of the natural vibration at a timing when the pointer enters into an area of an icon displayed on the display part and at a timing when the pointer comes out of the area of the icon.

5. The electronic device as claimed in claim 4, wherein the controlling part gives a second variation, which is different from the first variation, to the amplitude of the natural vibration while the pointer passes within the area of the icon.

6. The electronic device as claimed in claim 2, wherein the controlling part varies the amplitude of the natural vibration at a timing when the pointer crosses over a boundary of a window displayed on the display part.

7. The electronic device as claimed in claim 2,
wherein the display part includes a plurality of display panels, and
wherein the controlling part varies the amplitude of the natural vibration at a timing when the pointer crosses over a boundary between the plurality of the display panels.

8. An input apparatus usable by an electronic device that includes a display part, the input apparatus comprising:
an input manipulation part configured to receive a contact manipulation; and
a vibrating element attached to the input manipulation part and configured to vibrate at a natural vibration frequency of an ultrasound frequency band of the input manipulation part,
wherein a driving signal having a vibration pattern that differs in accordance with a positional change of a pointer displayed on the display part is input to the vibrating element, and
wherein the vibrating element vibrates in accordance with the vibration pattern.

9. A drive controlling method of an input apparatus usable by an electronic device that includes a display part, the drive controlling method comprising:
receiving a contact manipulation on an input manipulation surface of the input apparatus;
detecting a positional change of a pointer that moves, in response to the contact manipulation, on a display part;
generating a driving signal having an amplitude pattern that differs in accordance with the positional change of the pointer on the display part; and
generating a natural vibration in an ultrasound frequency band in the input manipulation surface based on the driving signal to vary an amplitude of the natural vibration.

10. The drive controlling method as claimed in claim 9, wherein an amplitude of the driving signal is varied when the pointer is located in or passes an area of a graphical user interface displayed on the display part.

11. The drive controlling method as claimed in claim 10,
wherein the amplitude of the driving signal is varied at a timing when the pointer enters into an area of an icon displayed on the display part, and
wherein the amplitude of the driving signal is maintained at a constant amplitude value while the pointer is located in the area of the icon.

12. The drive controlling method as claimed in claim 10, wherein a first variation is given to the amplitude of the driving signal at a timing when the pointer enters into an area of an icon displayed on the display part and at a timing when the pointer comes out of the area of the icon.

13. The drive controlling method as claimed in claim 12, wherein a second variation, which is different from the first variation, is given to the amplitude of the driving signal while the pointer passes within the area of the icon.

14. The drive controlling method as claimed in claim 10, wherein the amplitude of the driving signal is varied at a timing when the pointer crosses over a boundary of a window displayed on the display part.

15. The drive controlling method as claimed in claim 10,
wherein the display part is configured with a plurality of display panels, and
wherein the amplitude of the driving signal is varied at a timing when the pointer crosses over a boundary between the plurality of the display panels.
